(19) United States
(12) Patent Application Publication
(10) Pub. No.: US 2013/0029151 A1
(43) Pub. Date: Jan. 31, 2013

(54) FLAME-RESISTANT FINISH FOR INHERENTLY FLAME RESISTANT POLYMER YARNS AND PROCESS FOR MAKING SAME

(71) Applicants: Teresa C. Madeleine, Wilmington, DE (US); Bhatnagar Chitrangad, Richmond, VA (US)

(72) Inventors: Teresa C. Madeleine, Wilmington, DE (US); Bhatnagar Chitrangad, Richmond, VA (US)

(73) Assignee: E. I. DU PONT DE NEMOURS AND COMPANY, Wilmington, DE (US)

(21) Appl. No.: 13/361,995

(22) Filed: Jan. 31, 2012

Related U.S. Application Data
(60) Provisional application No. 61/454,182, filed on Mar. 18, 2011.

(51) Int. Cl. D02G 3/36; B05D 7/20

(52) U.S. Cl. 428/395; 428/394

(57) ABSTRACT

A synthetic fiber yarn and process for providing same, the yarn comprising a plurality of fibers of inherently flame resistant polymer having a surface finish of perfluorinated alkyl ether oil, wherein the perfluorinated alkyl ether has a molecular weight of from 1000 to 4730 and the yarn has a char length when burned of 6 cm or less.

### BACKGROUND OF INVENTION

1. Field of the Invention

This invention relates to a yarn provided with a finish oil; specifically yarns made with inherently flame resistant polymers provided with a flame-resistant finish oil.

2. Description of Related Art

U.S. Pat. No. 5,266,076 to Chitrangad et al. describes certain fluorinated compounds containing polar nitrogen groups used as fiber finishes.

Synthetic fiber yarns made from inherently flame resistant polymers have use in flame retardant apparel; such yarns are generally provided with a spin finish during manufacture to allow better processing through textile equipment. Such finishes are generally hydrocarbons; that is, they contain hydrogen and could possibly burn if exposed to flame. Therefore, in some high temperature applications a fiber provided with a finish oil that has increased flame-resistance is highly desired.

### BRIEF SUMMARY OF THE INVENTION

This invention relates to a synthetic fiber yarn comprising a plurality of fibers of inherently flame resistant polymer having a surface finish of perfluorinated alkyl ether oil, wherein the perfluorinated alkyl ether has a molecular weight of from 1000 to 4730; and wherein the yarn has a char length when burned of 6 cm or less.

This invention also relates to a process of providing a synthetic fiber yarn having a fire resistant finish comprising the steps of providing a yarn of a plurality of fibers of inherently flame resistant polymer; and applying a finish comprising perfluorinated alkyl ether oil to the surface of the yarn in an amount of 0.5 to 2 weight percent, based on the weight of the yarn with finish; wherein the perfluorinated alkyl ether has a molecular weight of from 1000 to 4730 and a viscosity of 15×10⁶ to 522×10⁶ m²/sec (15 to 522 centi-Stokes) at 20 degrees Celsius.

### DETAILED DESCRIPTION OF THE INVENTION

This invention relates to a synthetic fiber yarn comprising a plurality of fibers of inherently flame resistant polymer having a surface finish of perfluorinated alkyl ether oil, wherein the perfluorinated alkyl ether has a molecular weight of from 1000 to 4730; and wherein the yarn has a char length when burned of 6 cm or less. By char length, it is meant the length of yarn that is effectively removed or is not sufficiently attached to the yarn sample (that is, easily removed by the touch of a finger) after being exposed to a flame for 4 seconds as described herein.

By finish it is meant a substance or mixture of substances that is applied to the yarn to impart certain desired properties, generally reduced frictional properties, to reduce damage to the yarn when in contact with metal, fiber, and/or other contact surfaces. By surface finish it is meant that the finish has been applied to the surface of the filaments of the yarn and exists primarily on the surface of the filaments. Some of the filaments are substantially coated with the finish and have a thin film of the finish on the surface of the yarn. However, not all the filaments in the yarn need be fully coated with the finish; only enough of the yarn filaments should have the finish in an amount that provides adequate desired properties.

In some embodiments, the yarn provided with the surface finish has a fiber-to-metal hydrodynamic friction coefficient of 0.5 or less, preferably 0.4 or less. In some embodiments, the yarn provided with the surface finish has a fiber-to-fiber boundary friction coefficient of 0.4 or less, preferably 0.3 or less.

By oil it is meant the perfluorinated alkyl ether is a liquid, preferably having a viscosity of from 15×10⁶ to 522×10⁶ m²/sec (15 to 522 centi-Stokes) at 20 degrees Celsius. In some embodiments, the liquid has a viscosity of from 15×10⁶ to 200×10⁶ m²/sec (15-200 centi-Stokes) at 20 degrees Celsius. This allows the oil to be easily supplied and applied as a liquid to the surface of the yarn.

In some embodiments the perfluorinated alkyl ether is a fluorine end-capped homopolymer of hexafluoropropylene epoxide. In some embodiments the perfluorinated alkyl ether has a chemical structure of:

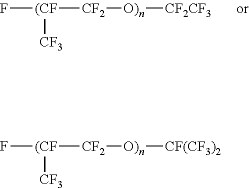

or mixtures thereof; wherein F is fluorine, C is Carbon, O is oxygen and n=10 to 60. In some embodiments, the ratio of the ethyl (CF₂CF₃) to the isopropyl (CF(CF₃)₂) terminal groups ranges between 20:11 to 50:1. Perfluorinated alkyl ethers can be obtained, for example, as described in Moore (U.S. Pat. No. 3,322,826) and Howell et al. (U.S. Pat. No. 6,753,301). Useful and preferred perfluorinated alkyl ether oils include oils such as Krytox® GPL 100, GPL 101, GPL 102, GPL 103, GPL 104, and GPL 105, all commercially available from E. I. du Pont de Nemours & Company, Wilmington Del. Specific information on these preferred oils is found in DuPont brochure H-58510-2 (07/08) “DuPont™ Krytox® Performance Lubricants”. General information about the Krytox® lubricant family is found in Dupont brochure H-58505-3 (04/10) “DuPont™ Krytox® Performance Lubricants: Product Overview”.

The perfluorinated alkyl ether oil has a molecular weight of about 1000 to 4730 as measured by fluorine-19 NMR. Molecular weights less than about 1000 are thought to be too volatile while molecular weights higher than about 4730 are thought to be too viscous for application to fiber. In some preferred embodiments, the molecular weight range is about 1100 to 2300. The oil can be applied neat to the fiber; however if desired, additives can be provided with the oil as long as they do not increase the flammability of the oil.

The amount of finish oil on the yarn is normally expressed as “percent finish on yarn” or “% FOY” and is preferably 0.5 to 2 weight percent; it is based on the weight of the extracted finish divided by the total weight of the yarn with finish, times 100. In some embodiments, the percent finish on yarn is 0.5 to 1.2 percent. In some embodiments % FOY is 1.0 percent or less. In some embodiments % FOY is 0.5 percent or more.

By inherently flame resistant polymer, it is meant the polymer resists burning in air without additional chemical fire retardants or coatings and has a limiting oxygen index of at least 26. Likewise a fiber made from an inherently flame resistant polymer has a Limiting Oxygen Index (LOI) of 26 or greater without the addition of any flame retardant chemicals. LOI is the minimum oxygen concentration that will just support flaming combustion in a flowing mixture of oxygen and nitrogen and is measured by techniques such as specified in ASTM D2863.

Useful inherently flame resistant polymers include polybenzazole, polypyridazole, polyoxazole, polyimidazole, polythioazole, aramid, or mixtures or copolymers of any of these. In some preferred embodiments, the aramid is poly(paraphenylene terephthalamide). In some embodiments the aramid is poly(metaphenylene isophthalamide).

Aramid polymers include, among other things, para-aramid polymers. By para-aramid polymer is meant aramid polymers wherein two rings or radicals are para-oriented with respect to each other along the molecular chain, such as the aforementioned poly(p-phenylene terephthalamide) (PPD-T), which is one preferred para-aramid polymer. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride; provided, only that the other aromatic diamines and aromatic diacid chlorides be present in amounts which do not adversely affect the properties of the para-aramid.

Additives can be used with the para-aramid in the polymer and it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid.

Para-aramid fibers and filaments are generally spun by extrusion of a para-aramid polymer solution through one or more capillaries into a coagulating bath. In the case of poly(p-phenylene terephthalamide), the solvent for the solution is generally concentrated sulfuric acid and the extrusion is generally through an air gap into an aqueous coagulating bath. Such processes are well known and are generally disclosed in U.S. Pat. Nos. 3,063,966; 3,767,756; 3,869,429, & 3,869,430. P-aramid fibers are available commercially as Kevlar® brand fibers, which are available from E. I. du Pont de Nemours and Company, and Twaron® brand fibers, which are available from Teijin, Ltd. Other polymers disclosed herein can be spun in to fibers and filaments using other processes and other solvents, if desired.

By yarn it is meant a continuous strand of fiber(s), filament(s), or material in a form suitable for knitting, weaving, or otherwise intertwining to form a textile fabric; or in a form suitable for unidirectional and multidirectional fabrics of all types; or in a form suitable as reinforcement for fiber optical cables and in other products. Yarns include, for example, (1) a plurality of filaments laid or bundled together without applied or intentional twist, sometimes referred to as a zero-twist yarn or a non-twisted yarn; (2) a plurality of filaments laid or bundled together and are either interlaced, have false-twist, or are bulked or textured in some manner; (3) a plurality of filaments laid or bundled together with a degree of twist, sometimes referred to as a twisted yarn; (4) a single filament with or without twist, sometimes referred to a monofilament or monofilament yarn, (5) a number of staple fibers or stretch broken fibers twisted together, sometimes referred to a spun yarn (or spun staple yarn) or stretch broken yarn, respectively; and (6) a narrow strip of material such as a slit film, with or without twist suitable for forming a textile fabric or use as reinforcement of products. Yarns also include what are commonly called multifilament yarns, which are generally yarns made from a plurality of filaments; and include ply-twisted yarns, which are made by twisting together two or more of the previously mentioned yarns.

In some embodiments the yarn is preferably a continuous multifilament yarn having a linear density of 200 to 3000 denier (220 to 3300 dtex). The individual filaments in the yarn can have a linear density of 0.1 to 6.0 denier (0.1 to 6.6 dtex) or higher. Preferably, the individual filaments have a linear density of 0.1 to 2.25 denier (0.1 to 2.5 dtex).

The yarn has an average char length when burned of 6 cm or less, meaning the applied surface finish does not adversely affect the inherent fire retardancy of the fiber. Hydrocarbon-containing oils generally used as fiber finishes tend to be inflammable and the addition of inflammable oils can limit in some applications the use of an otherwise inherently fiber retardant fiber. The inventors have found that perfluorinated alkyl ether finish oils have excellent performance when exposed to flame. It is believed the absence of hydrogen in perfluorinated alkyl ether finish oils, which contain only carbon, oxygen and fluorine and do not contain hydrogen like hydrocarbons, greatly increases the thermal stability of any finish in which the majority (50% or greater by weight) of finish is a perfluorinated alkyl ether oil. In some embodiments, at least 75% by weight of the finish is the perfluorinated alkyl ether oil. In some embodiments all or substantially all of the finish is perfluorinated alkyl ether oil, which renders it essentially nonflammable. In some embodiments the finish is perfluorinated alkyl ether oil that contains only carbon, oxygen, and fluorine.

The finished yarn has use in any application where a nonflammable fiber finish would be useful. While not being restrictive, the yarn has use in fiber optic and electro-mechanical cables, and can be used, for example, as either as a rip cord or as primary cable reinforcement or to reduce cable creep. The yarn can be used in a wide variety of cable designs, including those using multi-ended server, plaited, braided, spirally wound, parallel, and wire-lay constructions.

This invention also relates to a process of providing a synthetic fiber yarn having a fire resistant finish comprising the steps of providing a yarn of a plurality of fibers of inherently flame resistant polymer and applying a finish of perfluorinated alkyl ether oil to the surface of the yarn in an amount of 0.5 to 2 weight percent, based on the weight of the yarn with finish; wherein the perfluorinated alkyl ether has a molecular weight of from 1000 to 4730 and a viscosity of 15×10⁶ to 522×10⁶ m²/sec (15 to 522 centi-Stokes) at 20 degrees Celsius. In some embodiments, the liquid has a viscosity of from 15×10⁶ to 200×10⁶ m²/sec (15-200 centi-Stokes) at 20 degrees Celsius. In some preferred embodiments, the finish is applied to the yarn in the amounts necessary to provide the amount of % FOY previously stated herein. In some preferred embodiments, the finish has the viscosity as previously stated herein.

The finish is normally applied to the yarn as an on-line treatment, immediately after the yarn has been spun, neutralized and/or washed, dried, and optionally heat treated, just prior to winding the yarn up on a bobbin. Generally no further treatment is needed for the yarn after application of the finish oil. If desired, the finish can be applied with a ceramic or other finish applicator or a rotating roller provided with the necessary amount of finish to achieve the desired % FOY. The finish can be applied to the yarn at various rates, depending on the speed of the yarn. Representative rates are from 0.1 ml/hr to 5 ml/hr. In some preferred embodiments, the oil is supplied to the yarn in an amount of 5 to 10 ml of the finish oil to kilogram of yarn.

### Test Methods

The char length for a yarn was determined by modifying ASTM D6413-99 for fabric flammability testing as follows. A sample of yarn having a length of about 18 inches (46 cm) was obtained for testing. The flame height was set at 0.75 inches (1.9 cm) versus the height of 1.5 inches (3.8 cm) used for fabrics. The same ASTM chamber and U-frame having two folding halves was used to hang and test the yarn sample in a manner similar to a fabric; however, special provisions were made to hold the yarn test sample in place to help lessen the movement of the test sample during the application of the flame. The yarn was held in place by a combination of (a) a strip of Kapton® tape applied across one pair of the legs of one of the unfolded halves of the U-frame such that the bottom edge of the tape was 6 inches from the bottom (open) end of the frame legs; and (b) a loop of 200 denier (220 dtex) para-aramid yarn tautly-tied around the bottom (open) part of the U-frame at the very bottom ends of the two legs. The sample of yarn to be tested was then tied to the 200 denier yarn loop midway between the two U-frame legs, forming a small knot. The excess tail on the sample yarn was then cut from the knot and the knot centered between the two U-frame legs, even with the ends of the legs. The remaining end of sample yarn was then straightened and pressed onto the sticky surface of the Kapton® tape located 6 inches above the ends of the frame; the remaining end of the yarn was extended to the upper (closed) part of the frame. The other half of the U-frame then closed onto the half having the sample, and metal clips were applied to keep the two U-frame halves together.

The U-frame with sample, with the opening having sample knotted to the loop of 200 denier (220 dtex) yarn positioned at the bottom, was then hooked vertically in the test chamber. The burner flame was then slid directly under the center of the open frame such that the flame was co-centric with the axis of the yarn sample with the end tip of the flame at to the knotted end of the yarn. The flame was then held steady in this position for 4 seconds and was then removed. The sample was then removed from the frame after any subsequent after flame and/or afterglow of the sample had ceased. The yarn sample was then laid on a flat surface and the charred material was removed by the slide of a finger along the length of the yarn to remove any charred material not sufficiently attached to the yarn or strong enough to remain with the yarn. The length of the remaining yarn was then measured and the char length was calculated for the sample as the loss (difference) in the tested yarn sample length versus the original yarn sample length.

The percent finish-on-yarn (% FOY) was determined using a Dionex Accelerated Solvent Extractor (ASE) using a solvent. A sample of the yarn with the applied finish was weighed and then the finish was extracted from the yarn. The solvent was then evaporated and the extracted oil was then weighed. % FOY was then calculated using the equation:

% FOY=(Grams of extracted oil/Grams of yarn with the applied finish)×100

Fiber-to-metal hydrodynamic friction testing was performed per ASTM D3108.07, using a friction surface that was smooth chrome having a 4-6 micro-meter roughness; a yarn speed of 50 meters per minute; a yarn input tension of 30 grams; and a wrap angle of 180 degrees. The samples were conditioned and measured at 72 degrees F. (22 C) and 65% relative humidity.

Fiber-to-fiber boundary friction testing was performed per the twisted yarn method described in ASTM D3412.07, using three twists of the yarn; and input tension of 20 grams; and a yarn speed of 0.1 meter per minute. The samples were conditioned and measured at 72 degrees F. (22 C) and 65% relative humidity.

The Limiting Oxygen Index (LOI) of the polymer fibers is determined by techniques such as specified in ASTM D2863.

### Example 1

A perfluorinated alkyl ether oil (available as Krytox® GPL 102 oil from E. I. du Pont de Nemours & Company, Wilmington Del.) having a viscosity of 38 centi-Stokes (38×10⁶ m²/sec) at 20° C. was applied to a finish-free 600 denier (680 dtex) poly(paraphenylene terephthalamide) yarn using a ceramic applicator tip attached to a syringe pump; the yarn with finish was then wound onto a bobbin.

Sample 1 of the yarn was made by applying neat (100%) of the oil to the yarn in an amount of 7.6 ml oil/kg yarn at a nominal rate of 0.035 ml/min (2.1 ml/hr). The finish extraction was performed using hexane as the solvent. Sample 2 of the yarn was made in the same manner except the neat oil was applied in an amount of 3.4 ml oil/kg yarn at a rate of 0.22 ml/hr and the finish extraction was performed using a 50/50 mixture of trichloroethane and acetone was used as the solvent. Sample 3 of the yarn was made in the same manner as Sample 2 except the neat oil was applied in an amount of 8.7 ml oil/kg yarn at a rate of 0.44 ml/hr; again the extraction solvent was the 50/50 mixture of trichloroethane and acetone.

Samples 2 and 3 were then tested to determine their fiber-to-metal hydrodynamic and fiber to fiber boundary friction performance and their average char length. Data for the samples is shown in the Table.

TABLE

| | | Friction-To- | Friction-To- | Char Length |
|---|---|---|---|---|
| | Extracted | Metal | Fiber | (Average of |
| Sample | % FOY | Coefficient | Coefficient | 5 samples, cm) |
| 1 | 1.4 | 0.31 | 0.29 | — |
| 2 | 0.65 | 0.40 | 0.28 | ≦6 |
| 3 | 1.65 | — | — | ≦6 |

### Example 2

Example 1 is repeated, except up to 25% of an additive that does not contain hydrogen and does not increase the flammability of the finish is added to the perfluorinated alkyl ether oil, with similar expected results.

### Example 3

Example 1 is repeated except a finish-free yarn of a polybenzazole, polypyridazole, polyoxazole, polyimidazole, polythioazole, aramid (including poly(metaphenylene isophthalamide), or mixtures or copolymers of these is substituted for the 600 denier (680dtex) poly(paraphenylene terephthalamide) yarn with similar expected results.

### Example 4

Example 1 is repeated, once with a 200 denier (200 dtex) poly(paraphenylene terephthalamide) yarn and once with a 3000 denier (3300 dtex) poly(paraphenylene terephthalamide) yarn, in place of the 600 denier (680 dtex) poly(paraphenylene terephthalamide) yarn, with similar expected results.

What is claimed is:

1. A synthetic fiber yarn comprising a plurality of fibers of inherently flame resistant polymer having a surface finish of perfluorinated alkyl ether oil, wherein the perfluorinated alkyl ether has a molecular weight of from 1000 to 4730; and wherein the yarn has a char length when burned of 6 cm or less.

2. The yarn of claim 1 wherein the perfluorinated alkyl ether is a fluorine end-capped homopolymer of hexafluoropropylene epoxide.

3. The yarn of claim 1 wherein the perfluorinated alkyl ether has a chemical structure of 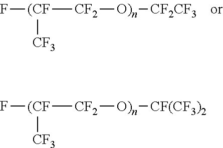
or mixtures thereof; where F is fluorine, C is Carbon, O is oxygen and n=10 to 60.

4. The yarn of claim 3 wherein the oil has a viscosity of 15×10⁶ to 522×10⁶ m²/sec (15 to 522 centi-Stokes) at 20 degrees Celsius.

5. The yarn of claim 1 wherein the amount of surface finish is 0.5 to 2 weight percent, based on the weight of the finish divided by the total weight of the yarn with finish times 100.

6. The yarn of claim 1 wherein the inherently flame resistant polymer is polybenzazole, polypyridazole, polyoxazole, polyimidazole, polythioazole, aramid, or mixtures or copolymers of any of these.

7. The yarn of claim 6 wherein the aramid is polyparaphenylene terephthalamide.

8. The yarn of claim 6 wherein the aramid is polymetaphenylene isophthalamide.

9. The yarn of claim 6 having a linear density of 200 to 3000 denier (220 to 3300 dtex).

10. A process of providing a synthetic fiber yarn having a fire resistant finish comprising the steps of:
a) providing a yarn of a plurality of fibers of inherently flame resistant polymer; and
b) applying a finish comprising perfluorinated alkyl ether oil to the surface of the yarn in an amount of 0.5 to 2 weight percent, based on the weight of the yarn with finish; wherein the perfluorinated alkyl ether has a molecular weight of from 1000 to 4730 and a viscosity of 15×10⁶ to 522×10⁶ m²/sec (15 to 522 centi-Stokes) at 20 degrees Celsius.

11. The process of claim 10 wherein the perfluorinated alkyl ether is a fluorine end-capped homopolymer of hexafluoropropylene epoxide.

12. The process of claim 10 wherein the perfluorinated alkyl ether has a chemical structure of 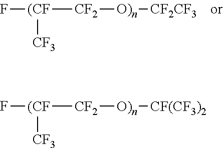
or mixtures thereof; where F is fluorine, C is Carbon, O is oxygen and n=10 to 60.

13. The process of claim 10 wherein the inherently flame resistant polymer is polybenzazole, polypyridazole, polyoxazole, polyimidazole, polythioazole, aramid, or mixtures or copolymers of any of these.

14. The process of claim 13 wherein the aramid is polyparaphenylene terephthalamide.

15. The process of claim 13 wherein the aramid is polymetaphenylene isophthalamide.
